(19) United States
(12) Patent Application Publication
(10) Pub. No.: US 2019/0031823 A1
(43) Pub. Date: Jan. 31, 2019

(54) POLYESTER RESIN COMPOSITION AND ARTICLE MANUFACTURED USING THE SAME

(71) Applicants: HYUNDAI MOBIS CO., LTD., Seoul (KR); LG CHEM, LTD., Seoul (KR)

(72) Inventors: Seung Yeon LEE, Cheonan-si (KR); Jong Su KIM, Yongin-si (KR); Jung Hwan LEE, Yongin-si (KR); Jung Won KIM, Daejeon (KR); Yi Seul JEON, Daejeon (KR); Min Cheol SHIN, Daejeon (KR); Soo Min LEE, Daejeon (KR)

(21) Appl. No.: 16/048,655

(22) Filed: Jul. 30, 2018

(30) Foreign Application Priority Data
Jul. 28, 2017 (KR) 10-2017-0095945

(51) Int. Cl. C08G 63/183; C08K 5/205; C08K 5/09; C08K 3/30; C08K 5/13; C08K 5/521; C08K 5/098; C08K 13/02

(52) U.S. Cl. CPC C08G 63/183; C08K 5/205; C08K 5/09; C08K 3/30; C08K 2003/3045; C08K 5/521; C08K 5/098; C08K 13/02; C08K 5/13

(57) ABSTRACT

The present invention relates to a polyester resin composition and a molded article produced therefrom. The polyester resin composition includes: about 80 wt % to about 98 wt % of a polybutylene terephthalate resin; about 0.1 wt % to about 5 wt % of a carbodiimide-based compound; about 0.1 wt % to about 5 wt % of a nucleating agent; and about 0.5 wt % to about 15 wt % of an inorganic filler having a non-spherical or non-circular cross-section.

### CROSS-REFERENCE TO RELATED APPLICATION

This application claims the benefit of Korean Patent Application No. 10-2017-0095945, filed on Jul. 28, 2017 in the Korean Intellectual Property Office, the entire disclosure of which is incorporated herein by reference.

### BACKGROUND OF THE INVENTION

### Field of the Invention

The present invention relates to a polyester resin composition and a molded article produced therefrom.

### Description of the Related Art

A headlamp (or headlight) for a vehicle is a lamp that illuminates ahead of the vehicle to ensure safe traveling. To collect light emitted from a light source and illuminate the light forward, the vehicle's headlamp includes a reflector and a bezel receiving the reflector. The bezel and the reflector are produced by depositing a metal on the surface of a substrate, and require a complex design and high gloss.

Since the gloss of the metal-deposited part is associated with the smoothness of the substrate, a desired level of gloss can be achieved by increasing the smoothness of the substrate. To this end, a method that performs deposition after increasing the smoothness by applying a primer to the substrate surface was used, but had problems of high costs and low productivity. For this reason, in recent years, a method that deposits a metal directly on the substrate surface by use of a material having high smoothness without applying the primer has been used.

Meanwhile, in order to produce a substrate having a complex design, a material for producing the substrate should have high flowability so that the substrate can be produced without a unmolded portion even in a complex mold structure. Thus, it is important to use a highly flowable material in substrate production.

In recent years, as a material that satisfies both high smoothness and high flowability required for the substrate for the headlamp as described above, polybutylene terephthalate resin has been used. The polybutylene terephthalate resin, a kind of polyester resin, has a short molding time due to its high crystallization rate, and is easily formed into a complex shape due to its high flowability. In addition, since the surface of an injection-molded article produced using this resin is smoother than those of other materials, this resin is used as a material on which a metal can be directly deposited.

However, the polybutylene terephthalate resin has the disadvantage of having high water absorption rate due to the effect of a functional group present in the polybutylene terephthalate structure. Meanwhile, when this polybutylene terephthalate resin is used under the conditions of low viscosity and low molecular weight to increase the flowability of the resin, the water-absorbing property thereof will further increase so that scission of the polymer chains can occur, resulting in an increase in the possibility of occurrence of haze in a part produced using the resin. In order to prevent the physical properties of this polybutylene terephthalate resin from being reduced due to water absorption, methods that form an anti-fog coating layer on the headlamp and change the structural design of the headlamp have been used, but have the disadvantage of increasing the production cost.

Meanwhile, as the design of the headlamp has been receiving attention as an important factor that determines the design of vehicles, the designs of the bezel, reflector and the like of the headlamp have become gradually more complicated and diversified. In addition, due to increases in light sources and electrical/electronic parts in functional terms, heat sources have been diversified. Such complicated structures and diversified heat sources can cause a difference in temperature between the inside and the outside of the headlamp so that the possibility of water generation can increase, thus causing problems.

Prior art documents related to the present invention include Korean Patent Application Publication No. 2002-0062403 (published on Jul. 26, 2002; entitled “Thermoplastic Polyester Resin Composition”).

### SUMMARY OF THE INVENTION

One aspect of the present invention is directed to a polyester resin composition. The polyester resin composition includes: about 80 wt % to about 98 wt % of a polybutylene terephthalate resin; about 0.1 wt % to about 5 wt % of a carbodiimide-based compound; about 0.1 wt % to about 5 wt % of a nucleating agent; and about 0.5 wt % to about 15 wt % of an inorganic filler having a non-spherical or non-circular cross-section.

In one embodiment, the polybutylene terephthalate resin may include a first polybutylene terephthalate resin having an intrinsic viscosity of about 0.95 dl/g to about 1.50 dl/g and a second polybutylene terephthalate resin having an intrinsic viscosity of about 0.80 dl/g to less than about 0.95 dl/g at a weight ratio of about 1:1 to about 1:1.5.

In one embodiment, the inorganic filler may include one or more of carbonate, sulfate and silicate.

In one embodiment, the nucleating agent may include one or more of nitrogen-based, montan-based and sodium-based nucleating agents.

In one embodiment, the inorganic filler and the polybutylene terephthalate resin may be included at a weight ratio of about 1:6 to about 1:45.

In one embodiment, the polyester resin composition may further include, based on the total weight of the polyester resin composition, about 0.1 wt % to about 5 wt % of a thermal stabilizer and about 0.1 wt % to about 5 wt % of a lubricant.

In one embodiment, the thermal stabilizer may include one or more of phosphorus-based thermal stabilizers and phenol-based thermal stabilizers, and the lubricant may include one or more of fatty acid ester-based lubricants and montan-based lubricants.

In one embodiment, the polyester resin composition may have a water content rate of about 0.13% or less as calculated according to the following equation 1 and a water repellency rate of about 0.13% or less as calculated according to the following equation 2:

water content rate (%)=((W₁−W₀)/W_{O})×100 Equation 1

wherein W₀ is a sample weight (g) measured immediately after drying a sample prepared using the polyester resin composition, and W₁ is a sample weight (g) measured after leaving the dried sample in a constant-temperature/constant-humidity chamber.

Water repellency rate (%)=((W₂−W₁)/W₁)×100 Equation 2

wherein W₁ is as defined in equation 1 above, and W₂ is a sample weight (g) measured after leaving a sample, prepared using the polyester resin composition, in a constant-temperature/constant-humidity chamber, and then drying the sample.

In one embodiment, the polyester resin composition may have a melt index of about 70 g/10 min to about 85 g/10 min as measured in accordance with ASTM D1238 at 250° C. under a load of 2.16 kg, and a heat deflection temperature of about 175° C. or higher as measured in accordance with ASTM D648 under a load of 4.6 kgf at a heating rate of 120° C./hr.

In one embodiment, the polyester resin composition may have an impact strength of about 35 J/nn or more as measured for a ¼″ test sample in accordance with ASTM D256, and a haze change of about 3.0% or less caused by volatiles in a fogging test performed at 130° C. for 5 hours.

In one embodiment, the polyester resin composition may have a tensile strength of about 50 MPa or higher as measured in accordance with ASTM D638, a flexural strength of about 90 MPa or higher as measured in accordance with ASTM D790, and a flexural modulus of about 2,700 or higher as measured in accordance with ASTM D790.

Another aspect of the present invention is directed to a molded article produced from the polyester resin composition.

In one embodiment, the molded article may be an automotive bezel or reflector.

When the polyester resin composition of the present invention is applied, it can show reduced water absorption and improved water repellency, since it has an excellent effect of controlling the crystallinity and crystallization rate of the polyester resin. In addition, it may have excellent flowability, compatibility, processability, smoothness, heat resistance and impact resistance.

### BRIEF DESCRIPTION OF THE DRAWINGS

FIG. 1 is a graph showing the results of differential scanning calorimetry of Example 1 of the present invention.

### DETAILED DESCRIPTION OF THE INVENTION

In the following description, the detailed description of related known technology will be omitted when it may obscure the subject matter of the present invention.

In addition, the terms of constituent elements, which will be described hereinafter, are defined in consideration of their functions in the present invention and may be changed according to the intention of a user or an operator, or according to the custom. Accordingly, definitions of these terms must be based on the overall description herein.

Polyester Resin Composition

One aspect of the present invention is directed to a polyester resin composition. In one embodiment, the polyester resin composition includes a polybutylene terephthalate resin, a carbodiimide-based compound, a nucleating agent, and an inorganic filler. In more specifically, the polyester resin composition includes: about 80 wt % to about 98 wt % of a polybutylene terephthalate resin; about 0.1 wt % to about 5 wt % of a carbodiimide-based compound; about 0.1 wt % to about 5 wt % of a nucleating agent; and about 0.5 wt % to about 15 wt % of an inorganic filler having a non-spherical or non-circular cross-section.

Hereinafter, the components of the polyester resin composition will be described in detail.

Polybutylene Terephthalate Resin

The polybutylene terephthalate (PBT) resin means a polybutylene terephthalate homopolymer and a polybutylene terephthalate copolymer.

In one embodiment, the polybutylene terephthalate resin may be produced by direct esterification, or transesterification and polycondensation, of 1,4-butanediol with terephthalic acid or dimethyl terephthalate.

In one embodiment, the polybutylene terephthalate resin may have a weight-average molecular weight of about 5,000 g/mol to about 200,000 g/mol. In this case, the polyester resin composition of the present invention may have excellent mechanical strength.

In one embodiment, the polybutylene terephthalate resin may include a first polybutylene terephthalate resin having an intrinsic viscosity of about 0.95 dl/g to about 1.50 dl/g and a second polybutylene terephthalate resin having an intrinsic viscosity of about 0.80 dl/g to less than about 0.95 dl/g at a weight ratio of about 1:1 to about 1:1.5. In this case, the miscibility of the polyester resin composition can be improved, and a molded article formed from the polyester resin composition may have excellent impact resistance, dimensional stability and appearance properties.

In another embodiment, the polybutylene terephthalate resin may include a first polybutylene terephthalate resin having an intrinsic viscosity of about 0.95 dl/g to about 1.50 dl/g and a second polybutylene terephthalate resin having an intrinsic viscosity of about 0.80 dl/g to less than about 0.95 dl/g at a weight ratio of about 1:1.1 to about 1:4.

In one embodiment, the intrinsic viscosity (IV) of the polybutylene terephthalate resin may be measured using o-chlorophenol solution (concentration: 0.5 g/dl) at 35° C.

In one embodiment, the polybutylene terephthalate resin is included in an amount of about 80 wt % to about 98 wt % based on the total weight of the polyester resin composition. If the polybutylene terephthalate resin is included in an amount of less than about 80 wt %, the flowability and moldability of the polyester resin composition may be reduced, and a molded article formed from the polyester resin composition may have reduced smoothness, dimensional stability and mechanical strength, and if the polybutylene terephthalate resin is included in an amount of more than about 98 wt %, the impact resistance may be reduced. For example, the polybutylene terephthalate resin may be included in an amount of about 80 wt % to about 93 wt %. For example, it may be included in an amount of 80, 81, 82, 83, 84, 85, 86, 87, 88, 89, 90, 91, 92, 93, 94, 95, 96, 97 or 98 wt %.

Carbodiimide-Based Compound

The carbodiimide-based compound is included for the purpose of ensuring the hydrolysis resistance of the polyester resin composition, and thus improving the polymer stability.

In one embodiment, the carbodiimide-based compound may include one or more of N,N′-dicyclohexylcarbodiimide, N,N′-diisopropylcarbodiimide, 1-ethyl-3-(3-dimethylaminopropyl)-carbodiimide, and N,N′-bis(2-methylphenyl)carbodiimide. When this component is applied, it may provide excellent hydrolysis resistance by end-capping the functional group of the polybutylene terephthalate resin.

In one embodiment, the carbodiimide-based compound is included in an amount of about 0.1 wt % to about 5 wt % based on the total weight of the polyester resin composition. If the carbodiimide-based compound is included in an amount of less than about 0.1 wt %, it may be difficult to ensure the hydrolysis resistance, and if the carbodiimide-based compound is included in an amount of more than about 5 wt %, the miscibility and moldability of the polyester resin composition may be reduced. For example, the carbodiimide-based compound may be included in an amount of about 0.1 wt % to about 3 wt %. For example, it may be included in an amount of about 0.1, 0.2, 0.3, 0.4, 0.5, 0.6, 0.7, 0.8, 0.9, 1, 1.5, 2, 2.5, 3, 3.5, 4, 4.5 or 5 wt %.

Nucleating Agent

The nucleating agent is included for the purpose of controlling the crystalline region of the polybutylene terephthalate resin, thereby increasing the crystallinity and crystallization temperature of the polybutylene terephthalate resin to thereby increase the crystallization rate of the polybutylene terephthalate resin.

Meanwhile, the crystallization rate of the polybutylene terephthalate resin may be determined by the following relation:

R=f(G, N)

wherein R is crystallization rate; G is the growth rate of crystalline nuclei; and N is the number of crystalline nuclei.

Referring to the above relation, it can be seen that when the nucleating agent is applied, it can increase crystallization rate by producing uniform crystalline structures while increasing the number (N) of crystalline nuclei.

When the nucleating agent is applied, crystallization can more easily occur while the polybutylene terephthalate resin chain is folded with respect to a nucleating site formed by the nucleating agent. Thus, when the nucleating agent is included, it can control the crystalline region of the polybutylene terephthalate resin so that the molecules of the resin can be arranged more densely and packed tightly together, and thus water penetration into the crystalline region cannot be easier than water penetration into the non-crystalline region, thereby reducing the water absorption of the polyester resin composition and improving the water repellency of the polyester resin composition.

In one embodiment, the nucleating agent may include one or more of nitrogen-based, montan-based and sodium-based nucleating agents. For example, it may include a nitrogen-based nucleating agent.

The nitrogen-based nucleating agent may include one or more of trimesic acid tris(t-butylamide), trimesic acid tricyclohexylamide, trimesic acid tri(2-methylcyclohexylamide), trimesic acid tri(4-methylcyclohexylamide), 1,4-cyclohexane dicarboxylic acid dianilide, 1,4-cyclohexanoic acid dicarboxylic acid dicyclohexylamide, 1,4-cyclohexanoic acid dicarboxylic acid dibenzylamide, 2,6-naphthalene dicarboxylic acid dicyclohexylamide, 1,2,3,4-butane tetracarboxylic acid tetracyclohexylamide, and 1,2,3,4-butane tetracarboxylic acid tetraanilide.

Examples of the montan-based nucleating agent that may be used in the present invention sodium montanate, calcium montanate, and the like.

The sodium-based nucleating agent may include a sodium ionomer. In one embodiment, the sodium ionomer may be formed by neutralizing at least a portion of a carboxylic acid, which is present in a copolymer of acrylic acid or methacrylic acid with an ethylene monomer, with sodium.

In one embodiment, the nucleating agent is included in an amount of about 0.1 wt % to about 5 wt % based on the total weight of the polyester resin composition. If the nucleating agent is included in an amount of less than about 1.0 wt %, it may be difficult to obtain the effect of increasing the crystallization rate of the polybutylene terephthalate resin, and if the nucleating agent is included in an amount of more than about 5 wt %, the miscibility and moldability of the polyester resin composition may be reduced. For example, the nucleating agent may be included in an amount of about 0.1 wt % to about 3 wt %. For example, it may be included in an amount of about 0.1, 0.2, 0.3, 0.4, 0.5, 0.6, 0.7, 0.8, 0.9, 1, 1.5, 2, 2.5, 3, 3.5, 4, 4.5 or 5 wt %.

Inorganic Filler

The inorganic filler that is used in the present invention has a non-spherical or non-circular cross-section. In one embodiment, the inorganic filler is in fibrous form, it may have a non-circular or plate-like cross-section, and when the inorganic filler is in particle form, it may have a non-spherical or plate-like cross-section.

When the inorganic filler having a non-spherical or non-circular cross-section is applied, it may exhibit an excellent effect of preventing water absorption, so that it may reduce the water absorption of the polyester resin composition and improve the water repellency of the composition.

In one embodiment, the inorganic filler may include a plate-like inorganic filler having a cross-sectional aspect ratio (cross-sectional long diameter/cross-sectional short diameter) of about 4 to 30 and a before-processing length of about 0.01 mm to about 5 mm. At this cross-sectional aspect ratio, the inorganic filler may have an excellent rigidity-enhancing effect and an excellent effect of reducing water penetration and diffusion rates by forming a lamination structure.

In another embodiment, the inorganic filler may include a flake-like inorganic filler having a cross-sectional aspect ratio of about 80 to about 200 and a before-processing length of about 0.01 mm to about 5 mm. At this cross-sectional aspect ratio, the inorganic filler may have an excellent rigidity-enhancing effect and an excellent effect of reducing water penetration and diffusion rates by forming a lamination structure.

In one embodiment, the inorganic filler may include one or more of carbonate, sulfate and silicate. In one embodiment, the carbonate may include one or more of calcium carbonate (CaCO₃), magnesium carbonate (MgCO₃), zinc carbonate (ZnCO₃) and barium carbonate (BaCO₃). In one embodiment, the sulfate may include one or more of barium sulfate (BaSO₄) and calcium sulfate (CaSO₄). In one embodiment, the silicate may include one or more of talc, Wollastonite, aluminosilicate, magnesium silicate and sodium silicate.

In one embodiment, the inorganic filler may be included in an amount of about 0.5 wt % to about 15 wt % based on the total weight of the polyester resin composition. If the inorganic filler is included in an amount of less than about 0.5 wt %, the effects of ensuring the heat resistance of the polyester resin composition, improving the water repellency of the composition and reducing the water absorption of the composition may be insignificant, and if the inorganic filler is included in an amount of more than about 15 wt %, the flexural modulus, flexural strength and moldability of the polyester resin composition may be reduced. For example, the inorganic filler may be included in an amount of about 2 wt % to about 8 wt %. For example, it may be included in an amount of about 0.5, 1, 1.5, 2, 2.5, 3, 3.5, 4, 6, 7 or 8 wt %.

In one embodiment, the inorganic filler and the polybutylene terephthalate resin may be included at a weight ratio of about 1:6 to about 1:45. When they are included at this weight ratio, the polyester resin composition may have excellent miscibility and moldability, the water absorption of the polyester resin composition may be reduced, and the water repellency of the composition may be improved. For example, the inorganic filler and the polybutylene terephthalate resin may be included at a weight ratio of about 1:8 to about 1:35. As another example, the inorganic filler and the polybutylene terephthalate resin may be included at a weight ratio of about 1:15 to about 1:30.

In one embodiment of the present invention, the polyester resin composition may further include a thermal stabilizer and a lubricant.

Thermal Stabilizer

The thermal stabilizer may include one or more of a phenol-based thermal stabilizer and a phosphorus-based thermal stabilizer. The phenol-based thermal stabilizer serves to remove radicals that occur during extrusion molding, and the phosphorus-based thermal stabilizer may be included for the purpose of removing peroxide components.

In one embodiment, the phenol-based thermal stabilizer may include one or more of N,N′-hexane-1,6-diyl-bis[3-(3,5-di-t-butyl-4-hydroxyphenyl propionamide)], pentaerythritol tetrakis[3-(3,5-di-t-butyl-4-hydroxyphenyl)propionate], N,N′-hexamethylene-bis(3,5-di-t-tert-4-hydroxy-hydroxycinnamide), triethyleneglycol-bis[3-(3-t-butyl-5-methyl-4-hydroxyphenyl)propionate], 3,5-di-t-butyl-4-hydroxybenzylphosphonate-diethylester, 1,3,5-trimethyl-2,4,6-tris(3,5-di-t-butyl-4-hydroxybenzyl)benzene, and 1,3,5-tris(4-t-butyl-3-hydroxy-2,6-dimethylbenzyl)isocyanurate.

The phosphorus-based thermal stabilizer may include one or more of triphenyl phosphite, tris(nonylphenyl)phosphite, tris(2,4-di-tert-butylphenyl)phosphite, tris(2,6-di-tert-butylphenyl)phosphite, tridecyl phosphite, trioctyl phosphite, trioctadecyl phosphite, didecylmonophenyl phosphite, dioctylmonophenyl phosphite, diisopropylmonophenyl phosphite, monobutyldiphenyl phosphite, monodecyldiphenyl phosphite, monooctyldiphenyl phosphite, bis(2,6-di-tert-butyl-4-methylphenyl)pentaerythritol diphosphite, 2,2-methylenebis(4,6-di-tert-butylphenyl)octyl phosphite, bis(nonylphenyl)pentaerythritol diphosphite, bis(2,4-di-tert-butylphenyl)pentaerythritol diphosphite, stearyl pentaerythritol diphosphite, tributyl phosphate, triethyl phosphate, and trimethyl phosphate.

When the above-described kind of thermal stabilizer is applied, it may further increase the heat resistance of the polyester resin composition and may also reduce gas generation.

In one embodiment, the thermal stabilizer may be included in an amount of about 0.1 wt % to about 5 wt % based on the total weight of the polyester resin composition. When the thermal stabilizer is included in this amount, it may prevent a reduction in the heat resistance of the polyester resin composition. For example, the thermal stabilizer may be included in an amount of about 0.1 wt % to about 3 wt %. For example, it may be included in an amount of about 0.5, 1, 1.5, 2, 2.5, 3, 3.5, 4, 6, 7 or 8 wt %.

Lubricant

The lubricant may further be included in order to ensure the release of an injection-molded article produced using the polyester resin composition. In one embodiment, the lubricant may include one or more of a fatty acid ester-based lubricant and a montan-based lubricant.

In one embodiment, the fatty acid ester-based lubricant may include one or more of alcohol or polyhydric alcohol fatty acid ester, hydrogenated oil, butyl stearate, monoglyceride stearate, pentaerythritol tetrastearate, stearyl stearate, ester wax, and alkyl phosphoric acid ester.

In one embodiment, the montan-based lubricant may include one or more of montanic acid ester, and metal salts of montanic acid. In one embodiment, the montanic acid ester wax may have a saponification value of about 20 mg KOH/g to about 300 mg KOH/g. When this montanic acid ester wax is applied, the polyester resin composition may have excellent miscibility and release properties.

In one embodiment, the lubricant may be included in an amount of about 0.1 wt % to about 5 wt % based on the total weight of the polyester resin composition. When the lubricant is included in this amount, the polyester resin composition may have excellent release and moldability properties. For example, the lubricant may be included in an amount of about 0.1 wt % to about 3 wt %. For example, it may be included in an amount of about 0.5, 1, 1.5, 2, 2.5, 3, 3.5, 4, 6, 7 or 8 wt %.

A polyester resin composition according to one embodiment of the present invention may be in the form of pellets obtained by mixing the above-described components and melt-extruding the mixture through a conventional twin-screw extruder at a temperature of about 200° C. to about 300° C., for example, about 220° C. to about 260° C.

In one embodiment, the polyester resin composition may have a water content rate of about 0.13% or less as calculated according to the following equation 1, and a water repellency rate of about 0.13% or less as calculated according to the following equation:

Water content rate (%)=((W₁−W₀)/W_{O})×100 Equation 1

wherein W₀ is a sample weight (g) measured immediately after drying a sample prepared using the polyester resin composition, and W₁ is a sample weight (g) measured after leaving the dried sample in a constant-temperature/constant-humidity chamber;

Water repellency rate (%)=((W₂−W₁)/W₁)×100 Equation 2

wherein W₁ is as defined in equation 1 above, and W₂ is a sample weight (g) measured after leaving a sample, prepared using the polyester resin composition, in a constant-temperature/constant-humidity chamber, and then drying the sample.

The water content rate and the water repellency rate of the polyester resin composition may be measured under various conditions. In addition, in equations 1 and 2, the sample drying time and temperature and the temperature and humidity of the constant-temperature/constant-humidity chamber may vary.

For example, the polyester resin composition may have a water content rate of about 0.05% to about 0.13% as calculated according to equation 1 above, and a water repellency rate of about 0.04% to about 0.13% as calculated according to equation 2 above.

In one embodiment, the polyester resin composition may have a melt index of about 70 g/10 min to about 85 g/10 min as measured in accordance with ASTM D1238 at 250° C. under a load of 2.16 kg, and a heat deflection temperature of about 175° C. or higher as measured in accordance with ASTM D648 under a load of 4.6 kgf at a heating rate of 120° C./hr. For example, the polyester resin composition may have a heat deflection temperature of about 175° C. to about 190° C.

In one embodiment, the polyester resin composition may have an impact strength of about 35 J/m or more as measured for a ¼″ test sample at 23° C. in accordance with ASTM D256, and a haze change of about 3.0% caused by volatiles in a fogging test performed at 130° C. for 5 hours.

For example, the polyester resin composition may have an impact strength of about 35 J/m to about 60 J/m and a haze change of about 0.5% to about 3.0% in a fogging test.

In one embodiment, the polyester resin composition may have a tensile strength of about 50 MPa or higher as measured in accordance with ASTM D638, a flexural strength of about 90 MPa or higher in accordance with ASTM D790 at a speed of 5 mm/min with a span of 100 mm, and a flexural modulus of about 2,700 MPa or higher in accordance with ASTM D790 at a speed of 5 mm/min with a span of 100 mm. For example, the polyester resin composition may have a tensile strength of about 50 MPa to about 65 MPa, a flexural strength of about 90 MPa to about 105 MPa, and a flexural modulus of about 2,700 MPa to about 3,000 MPa.

Molded Article Produced from Polyester Resin Composition

Another aspect of the present invention is directed to a molded article produced from the polyester resin composition. In one embodiment, the molded article may be an automotive bezel or reflector, but is not limited thereto.

When a molded article produced using the polyester resin composition of the present invention is applied, it may have reduced water absorption and improved water repellency properties, since the composition has an excellent effect of controlling the crystallinity and crystallization rate of the polyester resin. In addition, the composition may have excellent flowability, compatibility, processability, smoothness, heat resistance and impact resistance.

Furthermore, when the composition is applied to an automotive bezel or reflector, it can replace anti-fog coating, and thus can show the effect of reducing the production cost and increase productivity.

Hereinafter, preferred examples of the present invention will be described in further detail. It is to be understood, however, that these examples are for illustrative purposes only and are not intended to limit the scope of the present invention in any way.

### EXAMPLES AND COMPARATIVE EXAMPLES

The components used in the following Examples and Comparative Examples.

(A) Polybutylene terephthalate resin: (A1) A first polybutylene terephthalate resin having an intrinsic viscosity of 0.98 dl/g was used. (A2)

A second polybutylene terephthalate resin having an intrinsic viscosity of 0.83 dl/g was used.

(B) A carbodiimide-based compound was used.

(C) Nucleating agent: (C1) A montan-based nucleating agent was used. (C2) A nitrogen-based nucleating agent was used.

(D) Inorganic filler: (D1) As an inorganic filler, barium sulfate having a plate-like cross-section was used. (D2) As an inorganic filler, barium sulfate having a circular cross-section was used.

(E) Thermal stabilizer: (E1) As a phenol-based thermal stabilizer, pentaerythritol tetrakis(3-(3,5-di-t-butyl-4-hydroxyphenyl)propionate) was used. (E2) As a phosphorus-based thermal stabilizer, tributyl phosphate was used.

(F) Lubricant: (F1) As a montanic acid-based lubricant, sodium soap of montanic acid was used. (F2) A nitrogen-based lubricant was used.

### Examples 1 to 3 and Comparative Examples 1 to 11

The above-described components were added in the amounts shown in Tables 1 and 2 below, and then extruded through a twin-screw extruder under the conditions of barrel temperature of 240° C., screw rotating speed of 250 rpm and total discharge amount of 50 kg/h, thereby preparing pellet-type polyester resin compositions. The prepared pellets were dried at 120° C. for 4 hours, and then injection-molded in an injection molding machine at a temperature of 250° C., thereby preparing test samples.

TABLE 1

| Components | | Examples | | | Comparative Examples | | | |
|---|---|---|---|---|---|---|---|---|
| (unit: wt %) | | 1 | 2 | 3 | 1 | 2 | 3 | 4 |
| (A) | (A1) | 45 | 45 | 40 | — | — | 43 | 40 |
| | (A2) | 50 | 50 | 55 | 78 | 99 | 50 | 43 |
| (B) | | 0.2 | 0.2 | 0.2 | 2 | 0.1 | 2 | 0.2 |
| (C) | (C2) | 0.3 | 0.3 | 0.3 | 2 | 0.2 | 0.3 | 0.3 |
| (D) | (D1) | 4 | 4 | 3.8 | 14 | 0.5 | — | 16 |
| | (D2) | — | — | — | — | — | 4 | — |
| (E) | (E1) | 0.2 | — | 0.2 | 2 | 0.1 | 0.3 | 0.2 |
| | (E2) | — | 0.2 | 0.2 | — | — | — | — |
| (F) | (F1) | 0.3 | — | 0.3 | 2 | 0.1 | 0.4 | 0.3 |
| | (F2) | — | 0.3 | — | — | — | — | — |

| | | | | | | | |
|---|---|---|---|---|---|---|---|
| Sum | 100 | 100 | 100 | 100 | 100 | 100 | 100 |

TABLE 2

| Components | | Comparative Examples | | | | | | |
|---|---|---|---|---|---|---|---|---|
| (unit: wt %) | | 5 | 6 | 7 | 8 | 9 | 10 | 11 |
| (A) | (A1) | 42 | — | — | — | — | 25 | 32 |
| | (A2) | 47 | 93 | 91 | 94 | 95 | 74 | 63 |
| (B) | | 0.4 | 0.2 | 0.2 | 0.2 | 0.2 | 0.2 | 0.2 |
| (C) | (C1) | — | 0.3 | — | — | — | — | — |
| | (C2) | 6 | — | 0.3 | 0.3 | 0.3 | 0.3 | 0.3 |
| (D) | (D1) | 4 | 6 | 8 | 5 | 4 | — | 4 |
| | (D2) | — | — | — | — | — | — | — |
| (E) | (E1) | 0.3 | 0.2 | 0.2 | 0.2 | 0.2 | 0.2 | 0.2 |
| | (E2) | — | — | — | — | — | — | — |
| (F) | (F1) | 0.3 | 0.3 | 0.3 | 0.3 | 0.3 | 0.3 | 0.3 |
| | (F2) | — | — | — | — | — | — | — |

| | | | | | | | |
|---|---|---|---|---|---|---|---|
| Sum | 100 | 100 | 100 | 100 | 100 | 100 | 100 |

The physical properties of the test samples of the Examples and the Comparative Examples, prepared as described above, were evaluated, and the results of the evaluation are shown in Tables 3 and 4 below.

Methods for Evaluation of Physical Properties

(1) Tensile strength (MPa): Tensile strength was measured in accordance with ASTM D638 at a speed of 5 mm/min.

(2) Melt index (g/10 min): Melt index was measured in accordance with ASTM D1238 at 250° C. under a load of 2.16 kg.

(3) Flexural strength (MPa) and flexural modulus (MPa): Flexural strength and flexural modulus were measured in accordance with ASTM D790 at a speed of 5 mm/min with a span of 100 mm.

(4) Impact strength (Izod, J/m): Impact strength was measured in accordance with ASTM D256 (¼-inch sample).

(5) Heat deflection temperature (HDT, ° C.): Heat deflection temperature was measured in accordance with ASTM D648 under a load of 4.6 kgf at a heating rate of 120° C./hr.

(6) Shrinkage (%): Scales were marked on both ends of an injection molding mold, a 3.2 mm-thick test sample was injection-molded, and then scales marked on both ends of the test sample were measured. Shrinkage (%) was calculated according to the following equation 3:

Shrinkage (%)=((length between scales on both ends of mold−length between scales on both ends of test sample)/length between scales on both ends of mold)×100 Equation 3

(7) Fogging test (%): A haze change caused by volatiles in a fogging test performed at 130° C. for 5 hours was measured.

(8-1) Water content rate (%): For the compositions of the Examples and the Comparative Examples, water content rates were calculated according to the following equation 1. The water content rates of the polyester resin compositions of the Examples and the Comparative Examples may be measured under various conditions. In one embodiment, the water content rates of the test samples were measured the following drying temperature and time and constant-temperature/constant-humidity conditions.

Water content rate (%)=((W₁−W₀)/W_{O})×100 Equation 1

wherein W₀ is a sample weight (g) measured immediately after the test sample prepared using the polyester resin composition was dried at 120° C. for 12 hours, and W₁ is a sample weight (g) measured after the dried sample (W₀) was left in a constant-temperature/constant-humidity chamber (50% RH and 23° C.) for 48 hours.

(8-2) Water repellency rate (%): Using a water content analyzer (manufactured by METTLER TOLEDO; model: HR83), water repellency rate was calculated according to the following equation 2:

Water repellency rate (%)=((W₂−W₁)/W₁)×100 Equation 2

wherein W₁ is as defined in equation 1 above, W₂ is a sample weight (g) measured after the test sample prepared using the polyester resin composition was dried at 120° C. for 12 hours, left in a constant-temperature/constant-humidity chamber (50% RH and 23° C.) for 15 hours, and then dried at 80° C. for 75 minutes.

(9) Hardness: Rockwell hardness (M scale) was measured in accordance with ASTM D785.

(10) Specific gravity: Specific gravity was measured in accordance with ASTM D792.

TABLE 3

| | Examples | | | Comparative Examples | | | |
|---|---|---|---|---|---|---|---|
| Physical Properties | 1 | 2 | 3 | 1 | 2 | 3 | 4 |
| Tensile strength (MPa) | 56 | 55 | 56 | 49 | 48 | 51 | 52 |
| Melt index (g/10 min) | 75 | 76 | 75 | 66 | 76 | 77 | 68 |
| Flexural strength (MPa) | 96 | 95 | 95 | 83 | 81 | 79 | 76 |
| Flexural modulus (MPa) | 2890 | 2830 | 2880 | 2550 | 2480 | 2390 | 2310 |
| IZOD impact strength (J/m) | 39 | 38 | 40 | 31 | 33 | 34 | 34 |
| Heat deflection temperature (° C.) | 180 | 178 | 183 | 188 | 173 | 177 | 183 |
| Shrinkage (%) | 2.13 | 2.00 | 1.98 | 2.02 | 2.11 | 2.22 | 2.18 |
| Fogging test (%) | 2.5 | 3.0 | 2.5 | 4.5 | 5.5 | 6.0 | 6.5 |
| Water content rate (%) | 0.121 | 0.128 | 0.121 | 0.101 | 0.103 | 0.142 | 0.131 |
| Water repellency rate (%) | 0.121 | 0.125 | 0.127 | 0.114 | 0.116 | 0.143 | 0.135 |
| Rockwell hardness (M scale) | 85.6 | 85.4 | 85.2 | 85.1 | 85.1 | 85.4 | 85.3 |
| Specific gravity | 1.34 | 1.35 | 1.33 | 1.35 | 1.29 | 1.35 | 1.51 |

TABLE 4

| | Comparative Examples | | | | | | |
|---|---|---|---|---|---|---|---|
| Physical properties | 5 | 6 | 7 | 8 | 9 | 10 | 11 |
| Tensile strength (MPa) | 50 | 56 | 57 | 58 | 59 | 58 | 56 |
| Melt index (g/10 min) | 73 | 78 | 97 | 98 | 91 | 65 | 79 |
| Flexural strength (MPa) | 92 | 83 | 92 | 95 | 96 | 96 | 92 |
| Flexural modulus (MPa) | 2680 | 2480 | 2850 | 2920 | 2880 | 2830 | 2750 |
| IZOD impact strength (J/m) | 34 | 37 | 31 | 31 | 34 | 36 | 38 |
| Heat deflection temperature (° C.) | 181 | 177 | 182 | 179 | 181 | 180 | 171 |
| Shrinkage (%) | 2.08 | 2.09 | 2.11 | 2.17 | 2.09 | 2.11 | 2.17 |
| Fogging test (%) | 3.5 | 7.0 | 7.0 | 6.5 | 4.0 | 6.0 | 4.5 |
| Water content rate (%) | 0.138 | 0.112 | 0.109 | 0.115 | 0.122 | 0.120 | 0.118 |
| Water repellency rate (%) | 0.136 | 0.119 | 0.111 | 0.119 | 0.127 | 0.126 | 0.122 |
| Rockwell hardness (M scale) | 85.0 | 85.3 | 85.2 | 85.4 | 85.4 | 85.1 | 85.1 |
| Specific gravity | 1.34 | 1.38 | 1.38 | 1.36 | 1.34 | 1.34 | 1.34 |

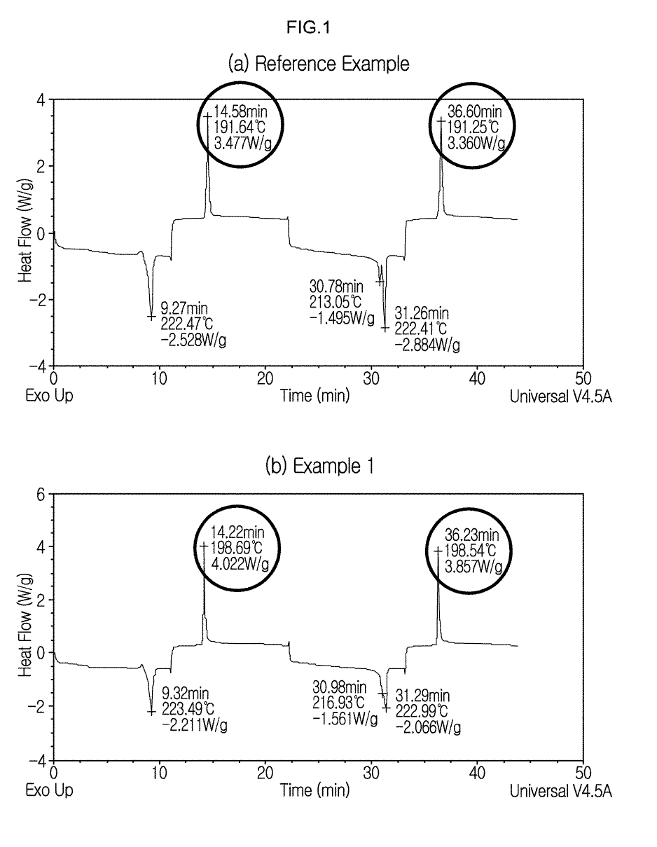

FIG. 1 is a graph showing the results of differential scanning calorimetry of Example 1 of the present invention. Referring to FIG. 1, it can be seen that Example 1 of the present invention has higher enthalpy higher than that of conventional polyester resin (Reference Example 1), suggesting that the polyester resin composition of Example 1 has high crystallization rate and crystallinity.

From the results in Tables 3 and 4 above, it could be seen that the polyester resin composition according to the present invention had excellent flowability, compatibility and processability, excellent physical properties, including smoothness, heat resistance, impact resistance and the like, reduced water absorption and improved water repellency, and showed low haze values in the fogging test, suggesting that it has excellent anti-fogging properties, so that when it is applied to an automotive bezel or reflector, it can replace anti-fog coating, thus reducing the production cost and increasing productivity.

However, in the case of Comparative Examples 1 and 2 in which the content of the polybutylene terephthalate resin was out of the content range of the present invention, the mechanical properties such as impact strength were lower than those of the Examples. In the case of Comparative Example 3 in which the inorganic filler having a circular cross-section was applied, the effects of reducing water absorption and improving water repellency were reduced. In the case of Comparative Example 4 in which the content of the inorganic filler exceeded the inorganic filler content of the present invention, the effects of improving water absorption and improving water repellency were reduced, and the impact strength and melt index values were reduced. In the case of Comparative Example 5 in which the content of the nucleating agent exceeded the nucleating agent content of the present invention, the mechanical properties and the effects of reducing water absorption and improving water repellency were reduced. In the case of Comparative Example 6 in which the montan-based nucleating agent was applied, the mechanical properties such as impact strength were reduced.

In addition, in the case of Comparative Examples 7 to 11 which were out of the mixing ratio of the polybutylene terephthalate resins having different intrinsic viscosities according to the present invention, the mechanical properties were lower than those of Examples 1 to 3.

Although the preferred embodiments of the present invention have been described for illustrative purposes, those skilled in the art will appreciate that various modifications, additions and substitutions are possible, without departing from the scope and spirit of the invention as disclosed in the accompanying claims.

What is claimed is:

1. A polyester resin composition comprising:
about 80 wt % to about 98 wt % of a polybutylene terephthalate resin;
about 0.1 wt % to about 5 wt % of a carbodiimide-based compound;
about 0.1 wt % to about 5 wt % of a nucleating agent; and
about 0.5 wt % to about 15 wt % of an inorganic filler having a non-spherical or non-circular cross-section.

2. The polyester resin composition of claim 1, wherein the polybutylene terephthalate resin comprises a first polybutylene terephthalate resin having an intrinsic viscosity of about 0.95 dl/g to about 1.50 dl/g and a second polybutylene terephthalate resin having an intrinsic viscosity of about 0.80 dl/g to less than about 0.95 dl/g at a weight ratio of about 1:1 to about 1:1.5.

3. The polyester resin composition of claim 1, wherein the inorganic filler comprises one or more of carbonate, sulfate and silicate.

4. The polyester resin composition of claim 1, wherein the nucleating agent comprises one or more of nitrogen-based, montan-based and sodium-based nucleating agents.

5. The polyester resin composition of claim 1, wherein the inorganic filler and the polybutylene terephthalate resin are contained at a weight ratio of about 1:6 to about 1:45.

6. The polyester resin composition of claim 1, further comprising, based on the total weight of the polyester resin composition, about 0.1 wt % to about 5 wt % of a thermal stabilizer and about 0.1 wt % to about 5 wt % of a lubricant.

7. The polyester resin composition of claim 6, wherein the thermal stabilizer comprises one or more of phosphorus-based thermal stabilizers and phenol-based thermal stabilizers, and the lubricant comprises one or more of fatty acid ester-based lubricants and montan-based lubricants.

8. The polyester resin composition of claim 1, wherein the polyester resin composition has a water content rate of about 0.13% or less as calculated according to the following equation 1 and a water repellency rate of about 0.13% or less as calculated according to the following equation 2:
Water content rate (%)=((W₁−W₀)/W_{O})×100 Equatino 3
wherein W₀ is a sample weight (g) measured immediately after drying a sample prepared using the polyester resin composition, and W₁ is a sample weight (g) measured after leaving the dried sample in a constant-temperature/constant-humidity chamber.
Water repellency rate (%)=((W₂−W₁)/W₁)×100 Equatino 2
wherein W₁is as defined in equation 1 above, and W₂ is a sample weight (g) measured after leaving a sample, prepared using the polyester resin composition, in a constant-temperature/constant-humidity chamber, and then drying the sample.

9. The polyester resin composition of claim 1, wherein the polyester resin composition has a melt index of about 70 g/10 min to about 85 g/10 min as measured in accordance with ASTM D1238 at 250° C. under a load of 2.16 kg, and a heat deflection temperature of about 175° C. or higher as measured in accordance with ASTM D648 under a load of 4.6 kgf at a heating rate of 120° C./hr.

10. The polyester resin composition of claim 1, wherein the polyester resin composition has an impact strength of about 35 J/m or more as measured for a ¼″ test sample in accordance with ASTM D256, and a haze change of about 3.0% or less caused by volatiles in a fogging test performed at 130° C. for 5 hours.

11. The polyester resin composition of claim 1, wherein the polyester resin composition has a tensile strength of about 50 MPa or higher as measured in accordance with ASTM D638, a flexural strength of about 90 MPa or higher as measured in accordance with ASTM D790, and a flexural modulus of about 2,700 or higher as measured in accordance with ASTM D790.

12. A molded article produced from a polyester resin composition according to claim 1.

13. The molded article of claim 12, wherein the molded article is an automotive bezel or reflector.
